(19) United States
(12) Patent Application Publication
(10) Pub. No.: US 2008/0237959 A1
(43) Pub. Date: Oct. 2, 2008

(54) SLIDE EXTENSION LOCATING SYSTEM FOR A CLAMPING APPARATUS

(76) Inventor: Chen-Hui TSENG, Taichung City (TW)

Correspondence Address: RABIN & Berdo, PC, 1101 14TH STREET, NW, SUITE 500, WASHINGTON, DC, 20005, US

(21) Appl. No.: 11/693,151

(22) Filed: Mar. 29, 2007

(51) Int. Cl. B25B 5/02

(52) U.S. Cl. 269/86

(57) ABSTRACT

An extension slide locating system for a press-and-pull clamping apparatus designed with slide insertion length adjustable depending on the specification of a work piece is essentially comprised of an extension slide and a slide inserted to each other; an insertion holder connected to the front end of the extension slide; a locating sleeve inserted to the insertion holder; locating sleeve being pushed to be inserted into the locking notch containing the insertion holder prevents the slide from being disengaged from the insertion holder to firmly maintain the insertion configuration in coping with the clamping operation among work pieces in different specifications.

### BACKGROUND OF THE INVENTION

(a) Field of the Invention

The present invention is related to a slide extension locating system for a clamping apparatus, and more particularly to one that permits readjustment of the clamping allowance between two clamping members depending on the size of a work piece to be clamped by having an insertion holder linked to one end of the extension slide to receive a slide, and the insertion portion to be contained by a locating sleeve provided to the insertion holder to maintain a firm insertion relation to allow selection of a slide in length depending on the size of the work piece to readjust the spatial allowance between two clamps for effectively correcting problems and flaws found with a fixed clamping apparatus of the prior art.

(b) Description of the Prior Art

whereas the conventional push-and-press clamping apparatus has its slide designed in a fixed length, the specification of a work piece to be clamped must be smaller than the length of the slide resulting in that a clamping apparatus with a longer slide must be separately provided. Consequently, in facing multiple work pieces in different sizes, the trader may have to prepare many sets of the clamping apparatus in various specifications causing inconvenient operation and increased operating cost to fail economic benefits and practical value.

To improve, attempts to provide a clamping apparatus to handle work pieces of different specifications by extending the length of the slide as taught in GB2411859A. As illustrated in FIGS. 1 through 4 of the accompanying drawings, a combined insertion holder (2)(2′) is linked to the front of an extension slide (1), a limit plate (3) is provided to the lower edge of the external end of the combined insertion holder (2) (2′), and a pair of L-shaped locking notches (4) (4′) are disposed on the inner surface of the combined insertion holder (2) (2′). A locating sleeve (5) is disposed on the combined insertion holder (2) (2′). A pair of bolting holes (6) (6′) on the insertion holder (2) corresponding to one side of the locating sleeve (5) to receive a bolt (7) for securing the locating sleeve (5) to the insertion holder (2). A limit portion (8) extending from the top edge of the locating sleeve (5) shelters both locking notches (4) (4′), so that the locating relation between the locating sleeve (5) and the combined insertion holder (2) (2′) is released by removing the bolt (7) when a slide (9) adapted with a mobile clamp is mounted to the extension slide (1), and the locating sleeve (5) is pushed to fully expose both locking notches (4) (4′) to allow the slide the slide (9) to be directly inserted from top to a clamping channel of the combined insertion holder (2) (2′); accordingly, with a pivot pin (not coded) of the slide (9) introduced by following both locking notches (4) (4′) functioning as axis, the slide (9) is outwardly pulled to achieve preliminary location of the insertion configuration before outwardly pushing the locating sleeve (5) to such extent that the limit portion (8) on the top edge of the locating sleeve to be contained in both locking notches (4) (4′) of the combined insertion holder (2) (2′) to prevent the slide (9) from being disengaged from its insertion configuration. The bolt (7) is retightened up to secure the locating sleeve (5) to the insertion holder (2) to maintain the insertion configuration of the clamping apparatus in coping with different specifications of various work pieces.

However, in the prior art, the locating sleeve and the insertion holder is bolted to each other to maintain firm configuration of insertion. The bolt must be first removed to push back the locating sleeve before inserting the slide to the insertion holder; and the bolt must be fastened once again when the locating sleeve pushes the limit slide to be inserted into the insertion holder for maintaining a firmly secured insertion configuration. The repeated mounting of the bolt consumes too much time thus to seriously affect the industrialization value of the clamping apparatus.

### SUMMARY OF THE INVENTION

The primary purpose of the present invention is to provide a slide extension locating system for a clamping apparatus that is adjustable depending on the specification of a work piece by means of an extension slide while allowing fast mounting and removal of the clamping apparatus to effectively upgrade its practicability and convenience.

Another purpose of the present invention is to provide slide extension locating system for a clamping apparatus that allows easily locating the insertion of slides by moving a locating sleeve instead of locking with a bolt to avoid inconvenient and time consuming as found with the prior art.

Another purpose yet of the present invention is to provide a slide extension locating system for a clamping apparatus that a bolting pin is disposed to the extension slide to adjust and secure the relation between a fixed clamp and the slide to cope with work pieces of different specifications.

To achieve these purposes, an insertion holder is linked to a front end of a slide; a locating sleeve is inserted to the insertion holder; and the end of the slide of the clamping apparatus is received in a clamping channel of the insertion holder in conjunction with a locking notch disposed in the outer end of the insertion holder. The slide is outwardly pulled with the pivoting pin in conjunction with the locking notch to achieve preliminary positioning for the insertion configuration between the extension slide and the slide, and finally by pushing the locating sleeve to be inserted into the locking notch containing the insertion holder prevents the slide from being disengaged from the insertion holder to firmly maintain the insertion configuration in coping with the clamping operation among work pieces in different specifications.

### BRIEF DESCRIPTION OF THE DRAWINGS

FIG. 1 is an exploded view of a press-and-press clamping apparatus of the prior at.

FIG. 2 is a schematic view showing the prior art as assembled.

FIG. 3 is a schematic view showing an operating construction of the prior art.

FIG. 4 is another schematic view showing an operating construction of the prior art.

FIG. 5 is a schematic view showing an extension slide of the clamping apparatus of the present invention.

FIG. 6 is an exploded view showing an insertion holder of the extension slide of the present invention.

FIG. 7 is a schematic view showing the insertion holder of the present invention as assembled.

FIG. 8 is a schematic view showing a construction of the clamping apparatus of the present invention.

FIG. 9 is a first schematic view showing slide insertion operation of the present invention.

FIG. 10 is a second schematic view showing slide insertion operation of the present invention.

FIG. 11 is a third schematic view showing slide insertion operation of the present invention.

FIG. 12 is a fourth schematic view showing slide insertion operation of the present invention.

FIG. 13 is a fifth schematic view showing slide insertion operation of the present invention.

FIG. 14 is a schematic view showing a construction of the present invention with a locating sleeve not yet secured in position.

FIG. 15 is a schematic view showing a constructional relation of the present invention with the locating sleeve not yet secured in position.

FIG. 16 is a schematic view showing a construction of the present invention with the locating sleeve already secured in position.

FIG. 17 is a schematic view showing a constructional relation of the present invention with the locating sleeve already secured in position.

FIG. 18 is a schematic view showing a general construction of a second preferred embodiment of the present invention.

FIG. 19 is a schematic view showing a construction of the second preferred embodiment of the present invention with the locating sleeve not yet secured in position.

FIG. 20 is a schematic view showing a construction of the second preferred embodiment of the present invention with the locating sleeve already secured in position.

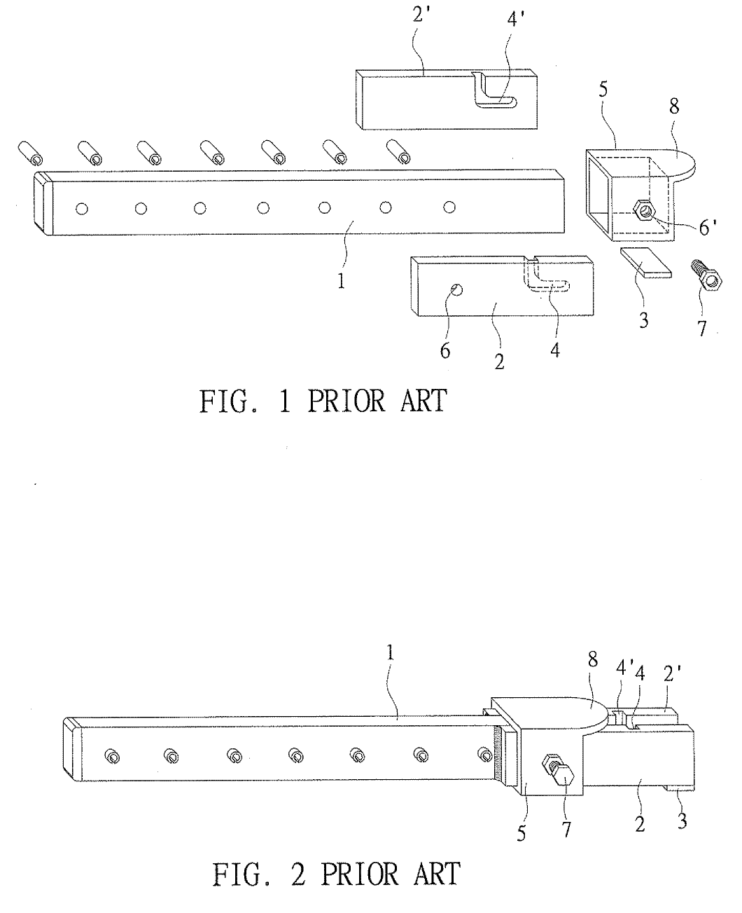

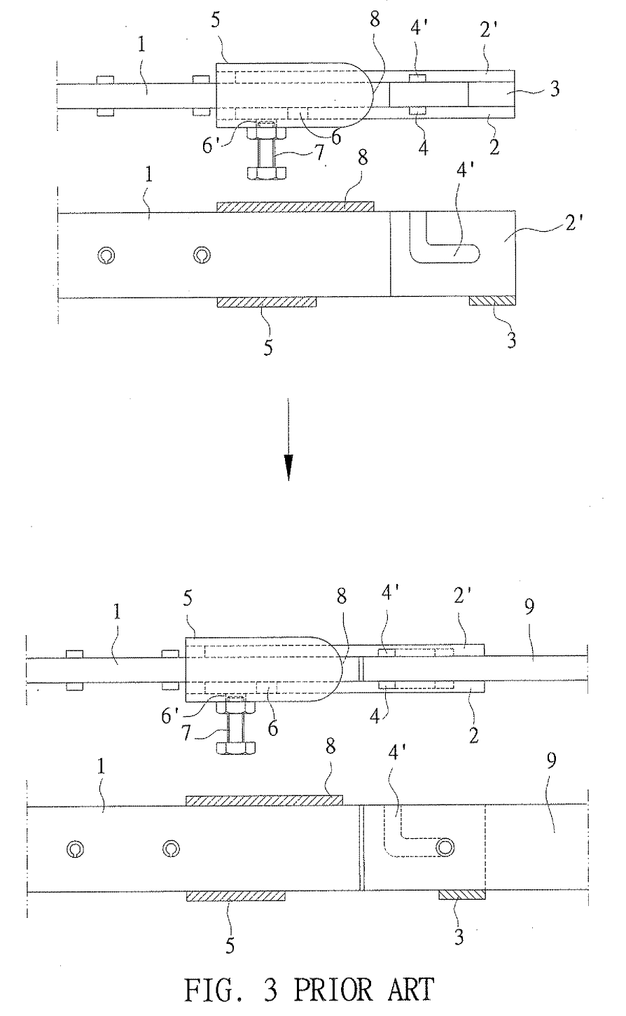

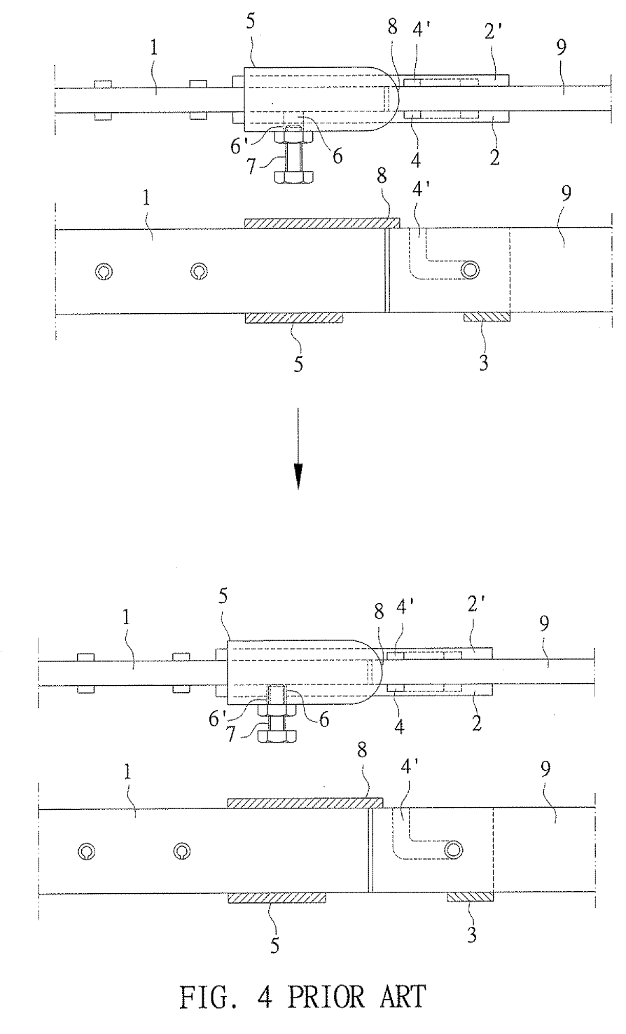

### DETAILED DESCRIPTION OF THE PREFERRED EMBODIMENTS

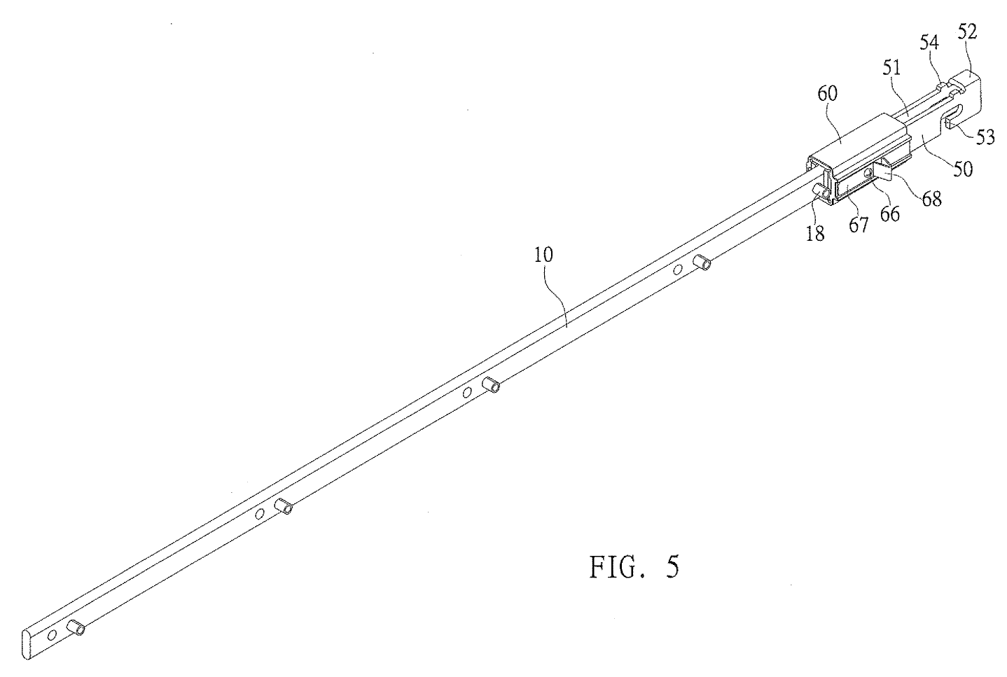

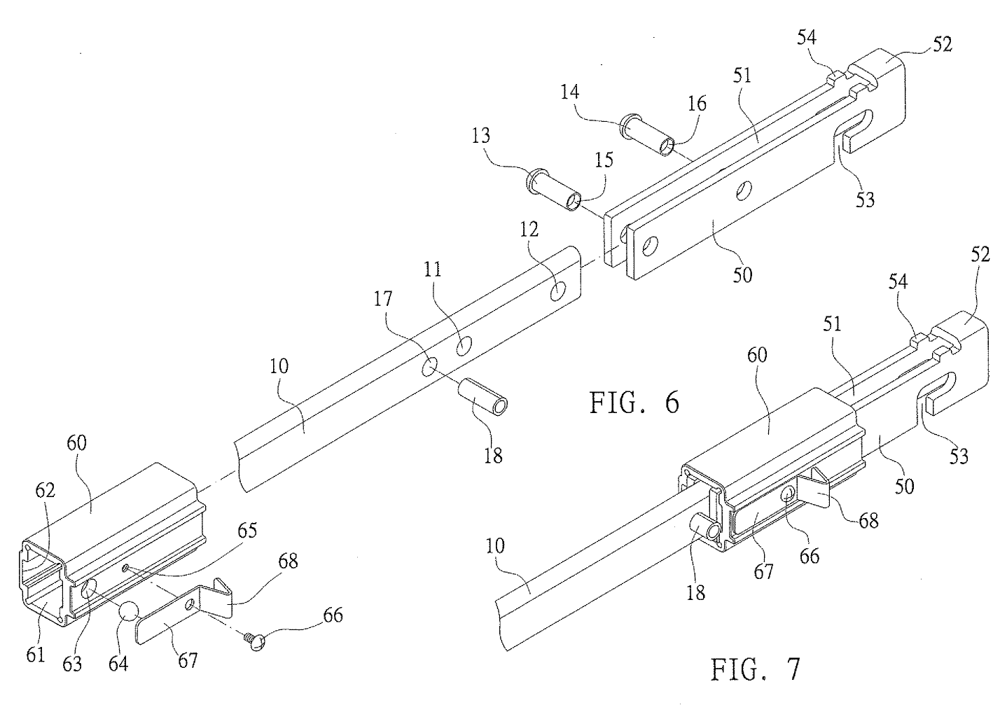

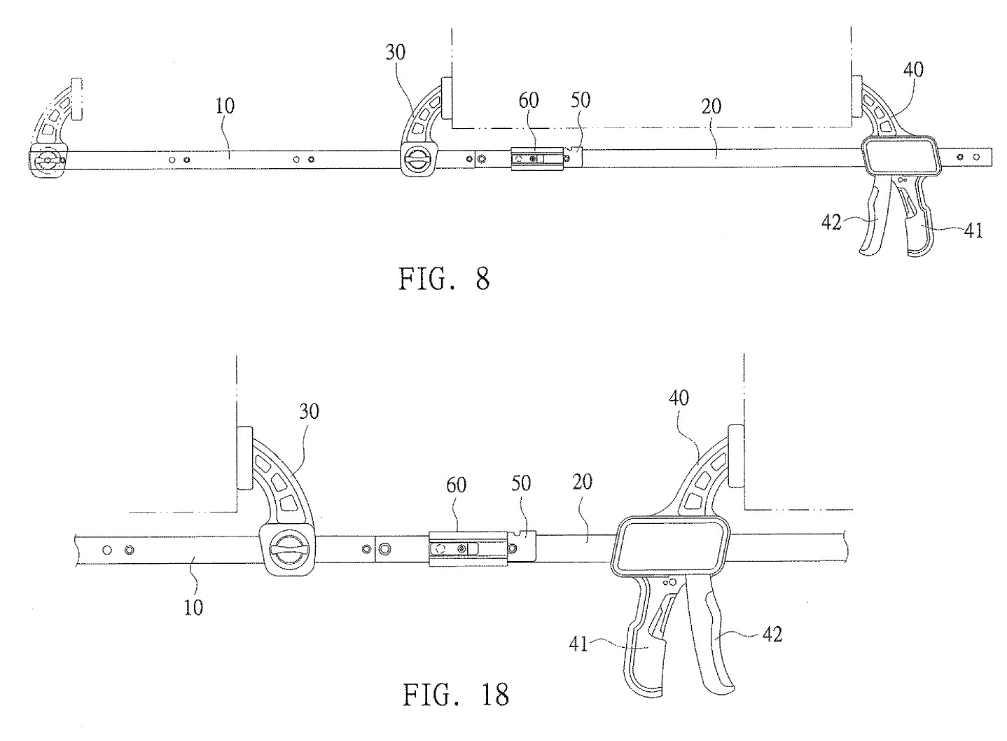

Referring to FIGS. 5, 6, 7, and 8, a preferred embodiment of the present invention related to a press-and-pull clamping apparatus is essentially comprised of an extension slide (10) and a slide (20) with both inserted to each other, a fixed clamp (30) disposed to the extension slide (10) with the mounting position adjustable as applicable, and a mobile clamp (40) disposed to the slide (20) and provided with a grip (41) and a press (42). Whereas the extension slide (10) is linked to the slide (20), manipulating the press (42) pulls the slide (20) and the extension slide (10) for the fixed clamp (30) mounted to the extension slid (10) to gradually move toward the mobile clamp (40) to achieve the purpose of clamping an object. To achieve the purpose of fast removal and mounting of the extension slide (10) and the slide (20), the present invention provides two bolting holes (11) (12) on an end of the extension slide (10) where to be inserted to the slide (20); two rivets (13) (14) secured the extension slide (10) to a insertion holder (50); and since each of both rivets (13) (14) has a hollow shank, two openings of both rivet (13) (14) respectively form two locating hole (15) (16). The insertion holder (50) is provided with a clamping channel (51) penetrating through the top and the bottom of the insertion holder (50) by leaving only at the upper edge of the front end of the insertion holder (50) an upper limit portion (52); an inverse L-shaped locking notch (53) is disposed at the lower edge of each of both sides of the rear end of the upper limit portion (52); and a pair of limit protrusions (54) are disposed on the upper edge of the insertion holder (50) at the front end of the locking notch (53). A locating sleeve (60) related to a tube is disposed on the rear end of the insertion holder (50). The locating sleeve (60) contains an insertion hole (61) to compromise the sectional profile of the insertion holder (50), and both sides of the insertion hole (61) are disposed with expansion grooves (62) to provide spatial allowance for both heads of those two rivets (13) (14) thus to permit the locating sleeve (60) to freely travel back and forth on the insertion holder (50). A bead recess (63) is disposed on the locating sleeve (60) at where proximate to its rear end to be filled with a steel ball (64). A screw hole (65) is disposed closer to the center of the locating sleeve (60) to lock a locating elastic member (67) by means of a screw (66). The elastic member (67) presses against the steel ball (64) and gives the steel ball (64) a certain allowance of mobility; so that the steel ball (64) is secured in position when contained by both locating holes (15) (16) of those two rivets (13) (14) to maintain the relation between the locating sleeve (60) and the insertion holder (50). Meanwhile, an outwardly protruding portion (68) is disposed to the front end of the elastic member (67) to facilitating push the sliding sleeve in traveling back and forth. A pinhole (17) is disposed to the extension slide (10) at where on the rear end of the insertion holder (50) to receive insertion of a limit pin (18) for preventing the locating sleeve (60) from breaking away from the insertion holder (50) when the locating sleeve (60) travels backward.

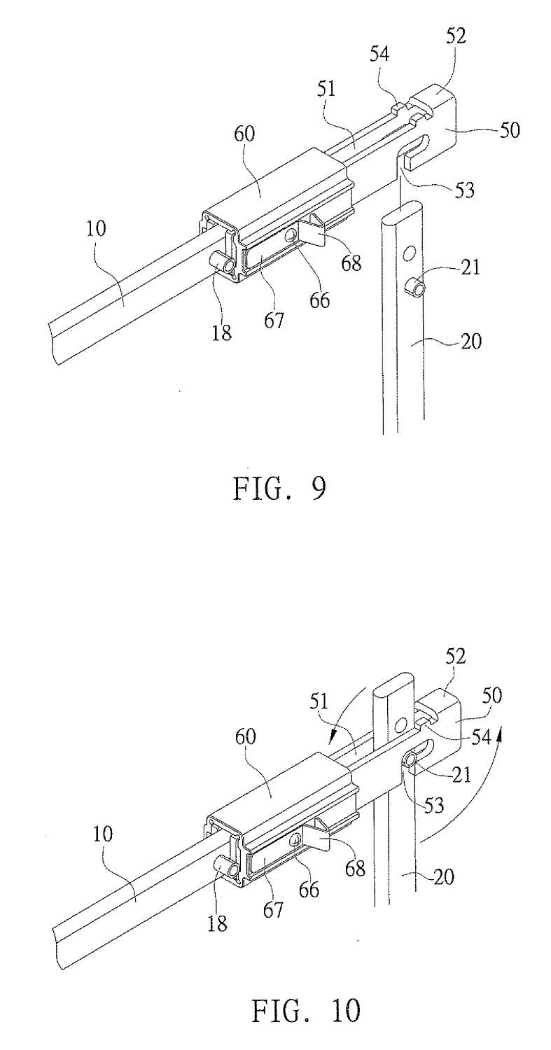

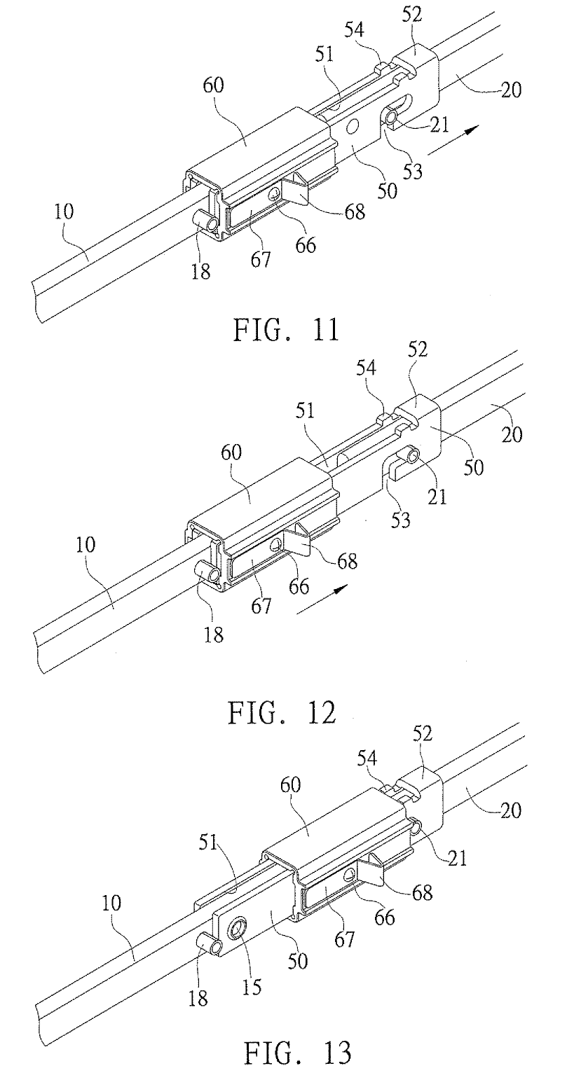

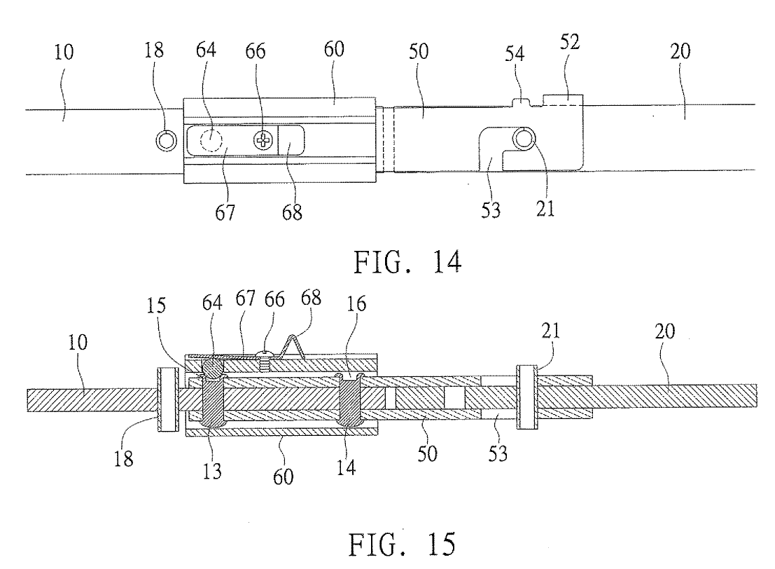

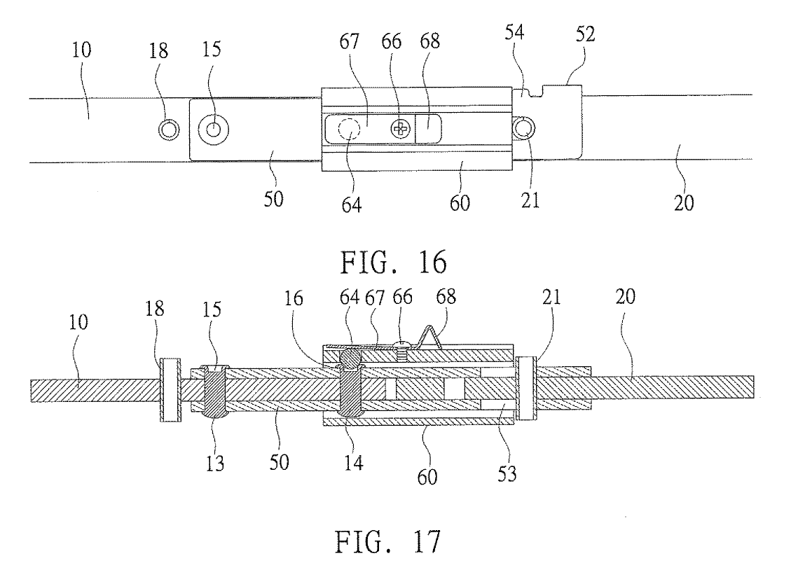

Now referring to FIGS. 9˜17 for describing the connection between the extension slide (20) and the slide (10) of the present invention, the insertion holder (50) linked to the extension slide (10) functions as an interface for insertion and the locating sleeve (60) functions to maintain the insertion in position essentially by having a locking pin (21) protruding from both insertion ends of the slide (20). Before inserting the slide (20) to the insertion holder (50), the locating sleeve (60) must be pushed back for the steel ball (64) of the locating sleeve (60) to be locked in the rear locating hole (15) of the insertion holder (50) so to fully expose the locking notch (53) for the slide (20) to stand at a right angle to the extension slide (10) with the locking pin (21) directed to the entrance of the locking notch (53). The slide (20) is inserted down to the clamping channel (51) of the insertion holder (50) and the locking pin (21) is directed to where the locking notch (53) takes it turn. The slide (20) with the locking pin (21) as the axis is turned to indicate horizontal status. The slide (20) is effectively prevented from being excessively turned for being subject to the upper limit portion (52) at the front end of the insertion holder (50). The slide (20) is pulled forward to such extent that the locking pin (21) travels along the horizontal section of the locking notch (53) to the utmost front end to complete the preliminary locating by insertion to the insertion holder (50). Finally, by pushing forward the locating sleeve until the front edge of the locating sleeve (60) is retained by the limit protrusion (54) at the upper edge of the insertion holder (50). The entrance of the locking notch (53) is screened by the locating sleeve (60) and the steel ball (64) of the locating sleeve (60) changes to be locked in the front locating hole (16) of the insertion holder (50) so to firmly maintain the insertion relation between the locating sleeve (60) and the insertion holder (50). The locking pin (21) of the slide (20) for being retained by the front edge of the locating sleeve (60) is restricted at the utmost front end of the locking notch (53) to prevent the slide (20) from being pushed backward or even from any attempted removal from the insertion holder (50) unless the locating sleeve (60) is pushed backward to operate the slide (20) in opposite direction for disengaged it from the insertion holder (50). Accordingly, both of the insertion holder (50) and the locating sleeve (60) allows fast mounting and removal between the extension slide (10) and the slide (20) while providing extremely firm locating result of inserting both of the extension slide (10) and the slide (20) to each other to secure smooth clamping and releasing operation of both clamps (30) (40) in coping with work pieces in different specifications.

As illustrated in FIG. 18 showing another clamping pattern of the present invention, both of the fixed and mobile clamps (30) (40) operate to clamp a work piece in a stretch-out fashion from within for providing wider range of applications to include more types of work piece.

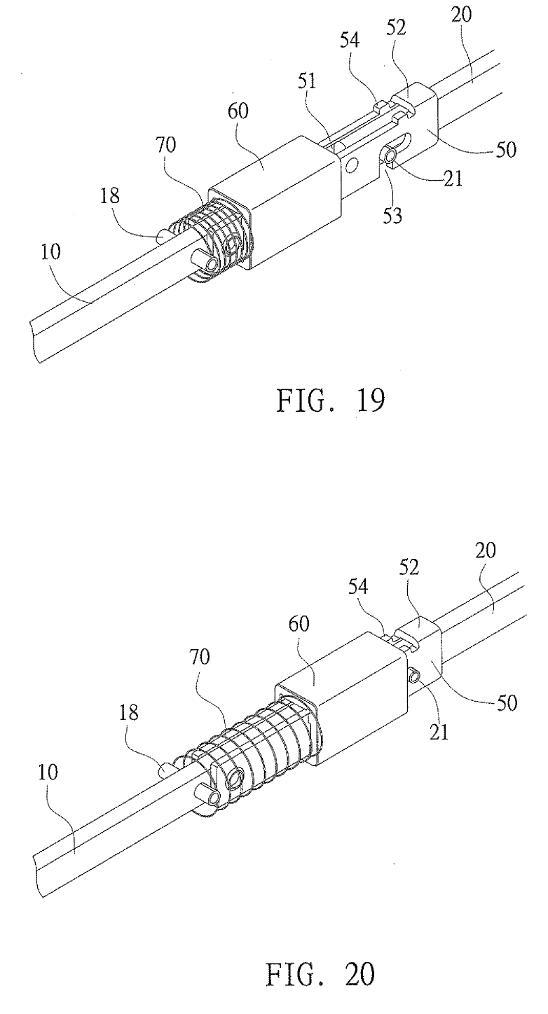

In another preferred embodiment of the present invention as illustrated in FIGS. 19 and 20, another feasible pattern of the relation between the insertion holder (50) and the locating sleeve (60) is provided without affecting the insertion structure and operation of the insertion between the extensions slide (10) and the insertion holder (50) with the only difference from that of the first preferred embodiment resting in that the locating slide (60) is secured in position without relying upon the steel ball, instead, upon a retaining coil (70) clamped between the rear end of the locating sleeve (60) and the limit pin (18) inserted to the rear end of the insertion holder (50). By having the retaining coil (70) to push against the locating sleeve (60), the locating sleeve (60) moves forward to contain and clamp the portion of the locking notch (53) that incorporates the slide (20) in the insertion holder (50) so to prevent the slide (20) from being disengaged from the insertion holder (50). To insertion or remove the slide (20), the locating sleeve (60) must be pulled back to compress the retaining coil (70) for the locking notch (53) to be fully exposed for facilitating the insertion or removal of the slide (20). Once the force to pull back the locating sleeve (60) is released, the return force from the retaining coil (70) automatically pushes the locating sleeve (60) to move forward in position.

The present invention by the design of the insertion holder in conjunction with the travel back and forward of the locating sleeve provides a firm maintenance performance for the insertion of the extension slide and the slide to each other for the clamping apparatus to operate in coping with work pieces of different specifications while permitting fast mounting and removal of the extension slide to and from the slide. In general, the present invention provides high value of industrialization to effective correct many problems and flaws found with the prior art.

1. An extension slide locating system for a press-and-pull clamping apparatus designed with slide insertion length adjustable depending on the specification of a work piece is essentially comprised of an extension slide and a slide inserted to each other; a fixed clamp mounted to the extension slide with its mounting position adjustable, a mobile clamp inserted onto the slide being disposed with a grip and a press for operating the press to pull the slide and the extension slide linked to the slide thus to gradually move the fixed clamp toward the mobile clamp to clamp the work piece; wherein, two bolting holes being disposed on the insertion end of the extension slide to receive mounting of an insertion holder; two rivets secured the extension slide to a insertion holder; a clamping channel penetrating through the top and bottom of the insertion holder; an upper limit portion being disposed on the upper edge of the front end of the insertion holder; an inverse L-shaped locking notch being turned upward and forward from the lower edge of each of both sides of the rear end of the upper limit portion; and a pair of limit protrusions being disposed on the upper edge of the insertion holder at the front end of the locking notch; a locating sleeve being inserted to the rear end of the insertion holder; the locating sleeve contains an insertion hole to compromise the sectional profile of the insertion holder, and both sides of the insertion hole being disposed with expansion grooves to provide spatial allowance for both heads of those two rivets thus to permit the locating sleeve to freely travel back and forth on the insertion holder to respectively secure the positioning in the front and the rear; both locking notches in the insertion holder being fully exposed with the locating sleeve being moved backwardly; the extension slide and the slide being completed with preliminary positioning by simple insertion and pull; and the locating sleeve being pushed forward into position to screen and limit both locking notches to achieve firm insertion configuration of the locating system.

2. An extension slide locating system for a press-and-pull clamping apparatus as claimed in claim 1, wherein a bead recess is disposed on the locating sleeve at where proximate to its rear end to be filled with a steel ball; a screw hole is disposed closer to the center of the locating sleeve to lock a locating elastic member by means of a screw; the elastic member presses against the steel ball and gives the steel ball a certain allowance of mobility; and the steel ball is secured in position when contained by both locating holes of those two rivets to maintain the relation between the locating sleeve and the insertion holder.

3. An extension slide locating system for a press-and-pull clamping apparatus as claimed in claim 1, wherein a bead recess is disposed on the locating sleeve at where proximate to its rear end to be filled with a steel ball; a screw hole is disposed closer to the center of the locating sleeve to lock a locating elastic member by means of a screw; the elastic member presses against the steel ball and gives the steel ball a certain allowance of mobility; the steel ball is secured in position when contained by both locating holes of those two rivets to maintain the relation between the locating sleeve and the insertion holder; and an outwardly protruding portion is disposed to the front end of the elastic member to facilitating push the sliding sleeve to move back and forth.

4. An extension slide locating system for a press-and-pull clamping apparatus as claimed in claim 1, wherein a pinhole is disposed to the extension slide at where on the rear end of the insertion holder to receive insertion of a limit pin for preventing the locating sleeve from breaking away from the insertion holder (50) when the locating sleeve travels backward.

5. An extension slide locating system for a press-and-pull clamping apparatus as claimed in claim 1, wherein a retaining coil is disposed between the rear end of the locating sleeve and the limit pin of the extension slide inserted to the rear end of the insertion holder to move the locating sleeve back and forth while providing automatic return force to the locating sleeve.
